(19) United States
(12) Patent Application Publication
(10) Pub. No.: US 2024/0143367 A1
(43) Pub. Date: May 2, 2024

(54) USING RULE ENGINE FOR MANAGING APPLICATION PROGRAMMING INTERFACE OBJECTS IN AN OPERATOR FRAMEWORK

(71) Applicant: Red Hat, Inc., Raleigh, NC (US)

(72) Inventors: Luca Molteni, Cernusco Sul Naviglio (IT); Matteo Mortari, Binasco (IT)

(21) Appl. No.: 17/975,858

(22) Filed: Oct. 28, 2022

(51) Int. Cl. G06F 9/455; G06F 9/50

(52) U.S. Cl. CPC G06F 9/45558; G06F 9/5072; G06F 9/541

(57) ABSTRACT

A method includes identifying an object by processing, by a processing device implementing a rule engine that utilizes a rule, a data item associated with a service defined by an application programming interface (API), wherein the data item associated with the service defined by the API comprises Custom Resource (CR) data; determining whether the object is an API object of a containerized computing cluster, wherein the containerized computing cluster comprises a plurality of virtualized computing environments running on one or more host computer systems; and responsive to determining that the object is an API object of the containerized computing cluster, adding the object to a definition of the containerized computing cluster.

### TECHNICAL FIELD

The present disclosure is generally related to rule engines, and more particularly, to using rule engine for managing application programming interface (API) objects in an operator framework.

### BACKGROUND

A rule engine processes information by applying rules to facts. A rule is a logical construct for describing the operations, definitions, conditions, and/or constraints that are applied to data to achieve a certain goal.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an example of a computer system architecture, in accordance with one or more aspects of the present disclosure.

FIG. 2 depicts a component diagram of an example of a container orchestration cluster, in accordance with one or more aspects of the present disclosure.

FIG. 3A depicts an example of defining a custom resource, in accordance with one or more aspects of the present disclosure.

FIGS. 3B and 3C depict examples of API rules, in accordance with one or more aspects of the present disclosure.

FIGS. 4 and 5 depict flow diagrams of example methods for using a rule engine for managing custom resources with an operator framework, in accordance with one or more aspects of the present disclosure.

FIG. 6 depicts a block diagram of an example computer system operating in accordance with one or more aspects of the present disclosure.

### DETAILED DESCRIPTION

Described herein are methods and systems for using rule engine for managing application programming interface (API) objects in an operator framework. Container orchestration systems, such as Kubernetes, can be used to manage containerized workloads and services, and can facilitate declarative configuration and automation. Container orchestration systems can have built-in features to manage and scale stateless applications, such as web applications, mobile backends, and application programming interface (API) services, without requiring any additional knowledge about how these applications operate. For stateful applications, like databases and monitoring systems, which may require additional domain-specific knowledge, container orchestration systems can use operators, such as Kubernetes Operator, to scale, upgrade, and reconfigure stateful applications.

“Operator” refers to an application for packaging, deploying, and managing another application within a containerized computing services platform associated with a container orchestration system. A containerized computing services platform refers to an enterprise-ready container platform with full-stack automated operations that can be used to manage, e.g., hybrid cloud and multicloud deployments. A containerized computing services platform uses operators to autonomously run the entire platform while exposing configuration natively through objects, allowing for quick installation and frequent, robust updates.

An operator can encode the domain-specific knowledge needed to scale, upgrade and reconfigure a stateful application into extensions (e.g., Kubernetes extensions) for managing and automating the life cycle of an application. More specifically, applications can be managed using an application programming interface (API), and operators can be viewed as custom controllers (e.g., application-specific controllers) that extend the functionality of the API to generate, configure, and manage applications and their components within the containerized computing services platform.

In a container orchestration system, a controller is an application that implements a control loop that monitors a current state of a cluster, compares the current state to a desired state, and takes application-specific actions to match the current state with the desired state in response to determining the current state does not match the desired state. An operator, as a controller, can monitor the target application that is being managed, and can automatically back up data, recover from failures, and upgrade the target application over time. Additionally, an operator can perform management operations including application scaling, application version upgrades, and kernel module management for nodes in a computational cluster with specialized hardware. Accordingly, operators can be used to reduce operational complexity and automate tasks within a containerized computing services platform, beyond the basic automation features that may be provided within a containerized computing services platform and/or container orchestration system.

An operator can create, modify or delete Custom Resources (CRs) to manage applications and their components. CRs are API endpoints that provide high-level configurations and settings. CRs can allow introduction of a custom API into a project or a cluster. A CR Definition (CRD) defines a CR and lists out the configurations available to users of the operator. The control loop of an operator can monitor a CR of given types and take application-specific actions to make the current state match the desired state. An operator can introduce new object types through CRD and handle these new objects like built-in objects. Thus, an operator can be a custom controller monitoring a custom resource.

Operators, such as Kubernetes Operator, are typically written using procedural programming languages. When a change is made in a CR, the operators will be notified of the change in the CR, compute the logic, create a specific object such as a new CR of another type, and add the new object definition to the definitions of the cluster. The limitation of this approach is that the custom logic that is semantically tied to a CR is not always immediately expressible when that logic is interweaved in the procedural programming languages. The change of the custom logic dealing with the change in a CR would require re-writing the logic in the procedural programming languages.

Aspects of the present disclosure address the above and other deficiencies by using a rule engine for managing API objects in an operator framework. The present disclosure provides a technique to utilize a rule engine to define, in a declarative way, the business rules inside an operator framework providing custom resources. A system according to the present disclosure creates or modifies an API rule by inserting, into the API rule, a data item associated with a service defined by an application programming interface (API) (e.g., a CR of a given type specified in a CRD) to provide resources to a containerized computing cluster. The containerized computing cluster includes one or more virtualized computing environments (e.g., virtual machines or containers) running on one or more host computer systems. For example, an API rule specifies, by its left-hand side, a condition including CR (e.g., a condition may include one or more constraints, and at least one constraint includes CR) and, by its right-hand side, at least one action to be performed if the condition of the rule is satisfied. The system implements a rule engine that is capable to evaluate the API rule against one or more facts (e.g., a fact associated with CR and asserted in a working memory of the rule engine) and, if part of the condition specified by the API rule is match by the facts, derive or identify an object from executing the action specified by the API rule. An object is a set of one or more data items organized in a specified format (e.g., in a tuple), and may further include one or more placeholders for elements, where each element represents, for example, a characteristic of an object. An object can be identified by evaluating an API rule and can be the same as or different from facts that are asserted to the rule engine. The facts can be of different types, including plain text, Extended Markup Language (XML) documents, database tables, Plain Old Java Objects (POJOs), predefined templates, comma separated value (CSV) records, custom log entries, Java Message Service (JMS) messages, etc.

Specifically, the system adds a fact (also referred to as asserts a fact) to a working memory of the rule engine, evaluates the API rule against the asserted fact by comparing the asserted fact to the constraint specified by the API rule, and based on a match between the asserted fact and the constraint of the API rule, execute the action specified by the API rule that can generate one or more API objects. As an illustrating example, an API rule can reflect a business policy or process, and a fact can be a specific state that is to be determined whether fit the business policy or process. After the system derives the object through evaluating the rule against the asserted fact, the system determines whether the derived object is an API object of a containerized computing cluster. An API object of a containerized computing cluster refers to a persistent entity (e.g., an entity in a persistent storage) in the API database (e.g., etcd) of the containerized computing cluster, and each entity represents the state of the containerized computing cluster. For example, the state of the containerized computing cluster may include identifiers of applications that are running (and respective node identifiers), identifiers of resources available to those applications, and definitions of policies for running those applications, such as restart policies, upgrades, and fault-tolerance. The API object of the containerized computing cluster can be a default API object or a domain knowledge API object.

Responsive to determining that the object is an API object of the containerized computing cluster, the system adds the object to the definitions of the containerized computing cluster (e.g., add the object to the set of API objects). Adding the object may involve adding the object to an API database of the containerized computing cluster for the purpose of, for example, creating or modifying data associated with custom resources. In some implementations, adding the object may result in change of data, including creating new asserted facts or modifying existing asserted facts, and these facts can be further used to evaluate the API rule or other rules. The system may recursively process as described above until there are no more unprocessed objects. For example, the system may receive an updated asserted fact as a result of adding the object, evaluate the API rule against the updated asserted fact, and derive a second object through the evaluation. The system may then determine whether the second object is an API object of the containerized computing cluster, and responsive to determining that the second object is an API object of the containerized computing cluster, the system adds the second object to the definition of the containerized computing cluster. The system continues the process until all objects derived from evaluation have been determined to be an API object of the cluster or not and have been added to the definition of the cluster according to the determination.

Advantages of the present disclosure include improving efficiency and speed of providing custom resources and reducing the usage of computational resources. Using the rule engine within an operator framework provides an efficient way to manage custom resources and API objects, which further reduces the coding work with the programming languages.

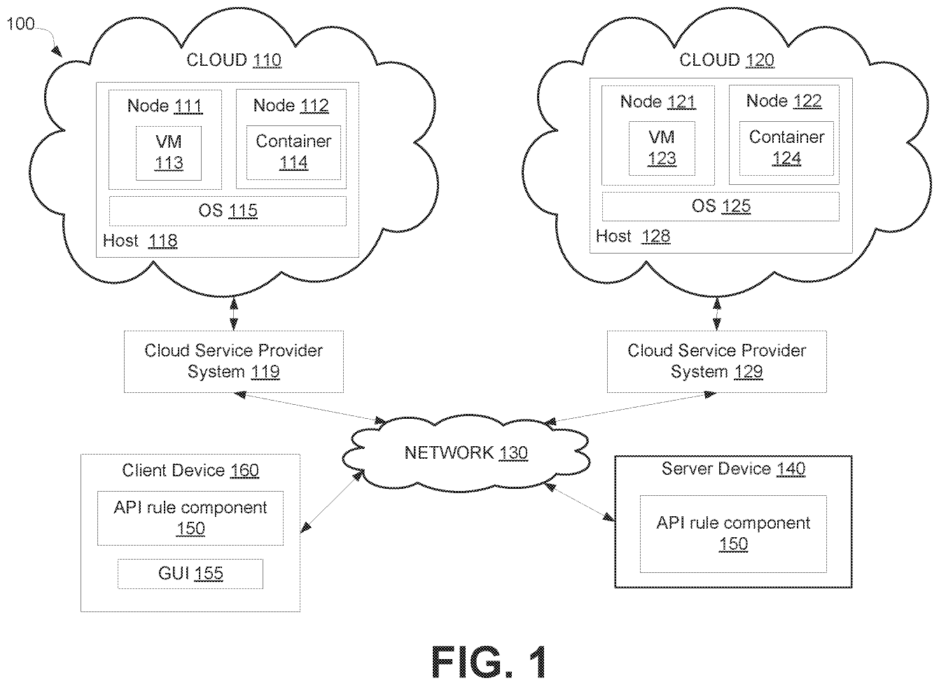

FIG. 1 is a block diagram of a network architecture 100 in which implementations of the disclosure may operate. In some implementations, the network architecture 100 may be used in a containerized computing services platform. A containerized computing services platform may include a Platform-as-a-Service (PaaS) system, such as Red Hat® OpenShift®. The PaaS system provides resources and services (e.g., micro-services) for the development and execution of applications owned or managed by multiple users. A PaaS system provides a platform and environment that allow users to build applications and services in a clustered compute environment (the “cloud”). Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

As shown in FIG. 1, the network architecture 100 includes one or more cloud-computing environment 110, 120 (also referred to herein as a cloud(s)) that includes nodes 111, 112, 121, 122 to execute applications and/or processes associated with the applications. A “node” providing computing functionality may provide the execution environment for an application of the PaaS system. In some implementations, the “node” may include a virtual machine (VMs 113, 123) that is hosted on a physical machine, such as host 118, 128 implemented as part of the clouds 110, 120. For example, nodes 111 and 112 are hosted on physical machine of host 118 in cloud 110 provided by cloud provider 119. Similarly, nodes 121 and 122 are hosted on physical machine of host 128 in cloud 120 provided by cloud provider 129. In some implementations, nodes 111, 112, 121, and 122 may additionally or alternatively include a group of VMs, a container (e.g., container 114, 124), or a group of containers to execute functionality of the PaaS applications. When nodes 111, 112, 121, 122 are implemented as VMs, they may be executed by operating systems (OSs) 115, 125 on each host machine 118, 128. It should be noted, that while two cloud providers systems have been depicted in FIG. 1, in some implementations more or fewer cloud service provider systems (and corresponding clouds) may be present.

In some implementations, the host machines 118, 128 can be located in data centers. Users can interact with applications executing on the cloud-based nodes 111, 112, 121, 122 using client computer systems (not pictured), via corresponding client software (not pictured). Client software may include an application such as a web browser. In other implementations, the applications may be hosted directly on hosts 118, 128 without the use of VMs (e.g., a “bare metal” implementation), and in such an implementation, the hosts themselves are referred to as “nodes”.

In various implementations, developers, owners, and/or system administrators of the applications may maintain applications executing in clouds 110, 120 by providing software development services, system administration services, or other related types of configuration services for associated nodes in clouds 110, 120. This can be accomplished by accessing clouds 110, 120 using an application programmer interface (API) within the applicable cloud service provider system 119, 129. In some implementations, a developer, owner, or system administrator may access the cloud service provider system 119, 129 from a client device (e.g., client device 160) that includes dedicated software to interact with various cloud components. Additionally, or alternatively, the cloud service provider system 119, 129 may be accessed using a web-based or cloud-based application that executes on a separate computing device (e.g., server device 140) that communicates with client device 160 via a network 130.

Client device 160 is connected to host 118 in cloud 110 and host 128 in cloud 120 and the cloud service provider systems 119, 129 via a network 130, which may be a private network (e.g., a local area network (LAN), a wide area network (WAN), intranet, or other similar private networks) or a public network (e.g., the Internet). Each client 160 may be a mobile device, a PDA, a laptop, a desktop computer, a tablet computing device, a server device, or any other computing device. Each host 118, 128 may be a server computer system, a desktop computer, or any other computing device. The cloud service provider systems 119, 129 may include one or more machines such as server computers, desktop computers, etc. Similarly, server device 140 may include one or more machines such as server computers, desktop computers, etc.

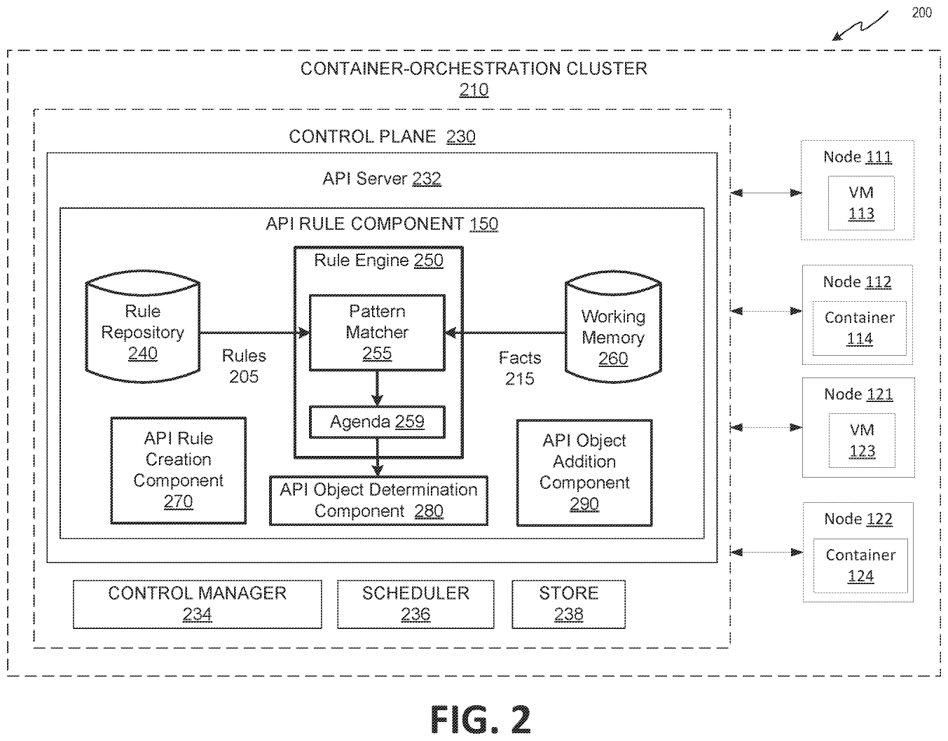

In some implementations, the client device 160 may include an API rule component 150, which can implement a rule engine for managing custom resources in an operator framework. The details regarding API rule component 150 implementing a rule engine for managing API objects in an operator framework will be described with respect to FIG. 2. API rule component 150 may be an application that executes on client device 160 and/or server device 140. In some implementations, API rule component 150 can function as a web-based or cloud-based application that is accessible to the user via a web browser or thin-client user interface that executes on client device 160. For example, the client machine 160 may present a graphical user interface (GUI) 155 (e.g., a webpage rendered by a browser) to allow users to input rule sets and/or facts, which may be processed using the API rule component 150. The process performed by API rule component 150 can be invoked in a number of ways, such as, e.g., a web front-end and/or a Graphical User Interface (GUI) tool. In some implementations, a portion of API rule component 150 may execute on client device 160 and another portion of API rule component 150 may execute on server device 140. While aspects of the present disclosure describe API rule component 150 as implemented in a PaaS environment, it should be noted that in other implementations, API rule component 150 can also be implemented in an Infrastructure-as-a-Service (IaaS) environment associated with a containerized computing services platform, such as Red Hat® OpenStack®. The functionality of API rule component 150 to using rule engine for managing API objects in an operator framework will now be described in further detail below with respect to FIG. 2

FIG. 2 illustrates an example system 200 that implements an API rule component 150. The system 200 includes a cluster 210. The cluster 210 is a cluster managed by a container orchestration system, such as Kubernetes. Using clusters can allow a business entity having multiple services requirements to manage containerized workloads and services and facilitate declarative configuration and automation that is specific to one service among the multiple services.

The cluster 210 includes a control plane 230 and a collection of nodes (e.g., nodes 111, 112, 121, 122). The control plane 230 is a collection of components that can make global control and management decisions about a cluster described below. The control plane 230 is responsible for maintaining the desired state (i.e., a state desired by a client when running the cluster) of the cluster 210, and such maintaining requires information regarding which applications are running, which container images applications use, which resources should be made available for applications, and other configuration details. The control plane 230 may include an API server 232, a control manager 234, a scheduler 236, and a store 238. The API server 232 can be used to define the desired state of the cluster 210. For example, the desired state can be defined by configuration files including manifests, which are JSON or YAML files that declare the type of application to run and the number of replicas required to run. The API server 232 can provide an API, for example, using JSON over HTTP, which provides both the internal and external interface. The API server can process and validate requests and update the state of the API objects in a persistent store, thereby allowing clients to configure workloads and containers across worker nodes. The API server can monitor the cluster 210, roll out critical configuration changes, or restore any divergences of the state of the cluster 210 back to what the deployer declared.

The control manager 234 can manage a set of controllers, such that each controller implements a corresponding control loop that drives the actual cluster state toward the desired state, and communicates with the API server to create, update, and delete the resources it manages (e.g., pods or service endpoints). For example, where the desired state requires two memory resources per application, if the actual state has one memory resource allocated to one application, another memory resource will be allocated to that application. The scheduler 236 can select a node for running an unscheduled pod (a basic entity that includes one or more containers/virtual machines and is managed by the scheduler), based on resource availability. The scheduler 236 can track resource use on each node to ensure that workload is not scheduled in excess of available resources. The store 238 is a persistent distributed key-value data store that stores the configuration data of the cluster, representing the overall state of the cluster at any given point of time.

The API server 232 can include an API rule component 150 that implements a rule engine for managing API objects in an operator framework according to the present disclosure. The API rule component 150 includes a API rule creation component 270 that inserts a CR item into an API rule and provides the API rule to a rule repository 240, a rule engine 250 that evaluates the rules (including the API rule), for example, by comparing the API rule with a fact from the retrieved data, the rule repository 240 and a working memory 260 in communication with the rule engine 250 for the evaluation, a API object determination component 280 that determines whether an object derived from evaluation of the rule is an API object of the cluster 210, and a API object addition component 290 that adds the object that is determined to be an API object of the cluster 210 to the cluster 210. Each component will be described in detail below.

The rule engine 250 can be a software that processes information by applying rules to facts. Initially, the rule engine 250 creates a stateless session for the working memory 260. A session allows a series of interactions with the rule engine over a predetermined period of time in which data objects asserted into the session are evaluated against rules. A session may be stateful or stateless. In a stateful session, a rule engine can assert and modify the data objects over time, add and remove the objects, and evaluate the rules; these steps can be repeated during the session, for example, over multiple iterations. In a stateless session, after a rule engine have added rules and asserted data objects at the beginning of the session, the evaluation of rules can be invoked only once; it is possible to initiate a new stateless session, where rules and data objects need to be asserted again to perform a new evaluation of rules.

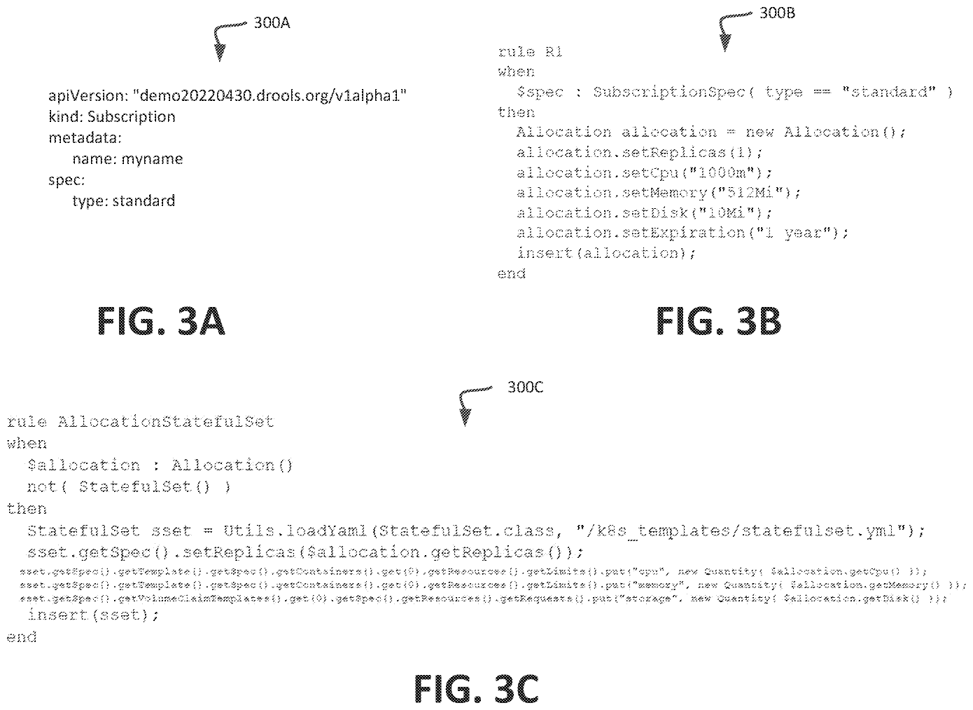

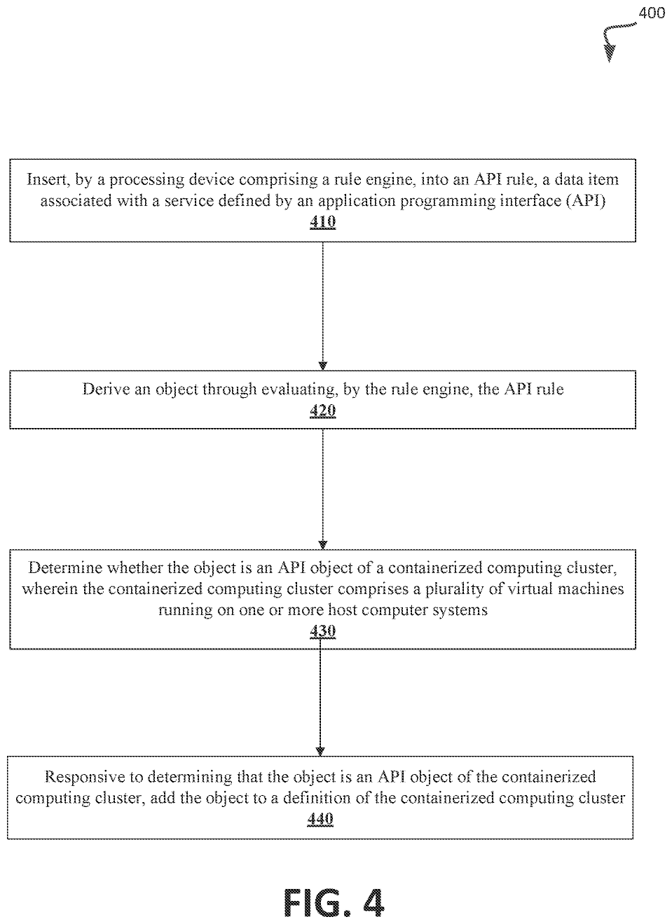

As described above, CRs are extensions of the API that is provided by the API server 232. A CR stores structured data that can have one or more fields, and the API server provides a mechanism for reading and setting the fields of the CRs. A CRD is the specification of constitution of a CR, and the CRD defines the allowed configuration values and the expected output that describes the current state of the custom resource. In particular, the CRD defines the fields of CRs and the types of values these fields contain. A CRD extends the API of a particular cluster (in the example of FIG. 2, the cluster 210). Thus, CRs can be represented by respective entries in the API database of the cluster 210 and can be created, accessed, updated, and deleted with common API server commands (e.g., kubectl). CRs can represent new collections of API objects. For example, an API object can represent the user input (e.g., “standard” as shown in FIG. 3A). In another example, an API object can represent the custom resource state.

The API rule creation component 270 can use a field of CR in the API database of the cluster 210 (also referred to as a CR item) (e.g., “standard” for a “Subscription” CR) and use it as a constraint of an API rule that can be applicable to a set of facts. The details regarding the rules and facts will be described below with respect to the rule repository 240, the working memory 260, and the rule engine 250. Each rule of the rules 205 has a left-hand side that specifies the constraints of the rule and a right-hand side that defines one or more actions to perform if the constraints of the rule are satisfied. Techniques to specify rules can vary, including using Java objects to describe rules, using a Domain Specific Language (DSL) to express rules, or using a GUI to enter rules. The rules 205 can be defined using a scripting language or other programming language, and can be in a format of a data file or an Extended Markup Language (XML) file, etc.

The API rule creation component 270 can convert the CRs into a declarative logic by inserting the CR into API rule(s). As the example illustrated in FIG. 3B, a user deploying a subscription service based on a CRD can decide to allocate different resources to different types of the subscription, and to implement it, the API rule creation component 270 can write into an API rule with a left-hand side stating a constraint that the type of the subscription needs to be a specific type (e.g., type==“standard”) and a right-hand side stating an action of specific allocation of resources (e.g., replicas “1,” CPU “1000 m,” memory “512Mi,” disk “10Mi,” expiration “1 year,” etc.). As the example illustrated in FIG. 3C, the user deploying a subscription service based on a CRD can decide to allocate a Stateful Set for each allocation of resources, and to implement it, the API rule creation component 270 can create a rule with a left-hand side stating a constraint that the allocation of resources does not include a StatefulSet and a right-hand side stating an action of adding a StatefulSet to the allocation. StatefulSet refers to the workload API object used to manage stateful applications, and it manages the deployment and scaling of a set of pods and provides guarantees about the ordering and uniqueness of these pods.

The API rule creation component 270 can store the API rules in the rule repository 240. The rule repository 240 (also referred to as the production memory) may include an area of memory and/or secondary storage that stores the rules (including the API rules) that will be used to evaluate against facts. The rule repository 240 may include one or more file systems, may be a rule database, may be a table of rules, or may be some other data structure for storing a rule set.

The rule engine 250 can receive the rules (including the API rules) from the rule repository 240 and evaluate the rules (including the API rules). In some implementations, the rule engine 250 can include a pattern matcher 255 to evaluate the rules 205 from the rule repository 240 against 215 facts from the working memory 260. The facts 215 can be data objects that are input by a user (e.g., a business entity or its client). In the example of FIG. 3B, the facts can be object such as “SubscriptionSpec” of type “standard,” “premium,” or “trial,” representing that a client has a subscription type as a standard type of subscription, a premium type of subscription, a trial type of subscription, respectively. In the example of FIG. 3C, the facts can be “not (StatefulSet( ))” or “(StatefulSet( )),” representing that the working memory does not contain a StatefulSet or a StatefulSet is present in the working memory (for example, the fact can be asserted as a result of execution of an action specified by a rule), respectively. In some implementations, the facts can be in a serialized form, such as in a binary stream, and the rule engine 250 may deserialize the binary stream and convert it into a format useable by the rule engine 250. In some implementations, each fact can be assigned an identification (e.g., an integer), and the identification is placed in a map and written to a binary stream to allow the rule engine 250 of identifying the fact later. In some implementations, the facts can be written to a binary stream via standard readObject method and writeObject method. In some implementations, each fact can be a unit of data organized in a user-defined format, for example, each fact is an element in a tuple. In some implementations, the facts may include a set of one or more placeholders for elements (e.g., an element representing a characteristic of a fact). For example, for a subscription service application, an element named “type” may be defined to hold a type of customer for the subscription service.

To evaluate the rules, the rule engine 250 may use e.g., a Rete algorithm that defines a way to organize facts in a pre-defined structure and allows the rule engine to generate conclusions and trigger actions on the facts according to the rules. Specifically, the rule engine 250, via the pattern matcher 255, may implement a logical network (such as a Rete network) to process the rules and the facts. A logical network may be represented by a network of nodes. For example, each node (except for the root node) in a Rete network corresponds to a pattern appearing in the left-hand side (the condition part) of a rule, and the path from the root node to a leaf node defines a complete rule left-hand side of a rule.

The pattern matcher 255 can use the Rete network to evaluate the rules against the facts. For example, the pattern matcher 255 receives from the rule repository 240 one of a plurality of rules 205, and the pattern matcher 255 receives at least one input fact 215 from working memory 260. The pattern matcher 255 may have each network node corresponding to a portion of the condition (e.g., the condition including multiple constraints, and the portion corresponding to one constraints) appearing in the left-hand side of the rule, and the pattern matcher 255 may have a path from the root node to the leaf node corresponding to the entire condition (e.g., multiple constraints included in the condition) in the complete left-hand side. The pattern matcher 255 may allow the fact 215 from the working memory 260 propagate through the logical network by going through each node and annotate the node when the fact matches the pattern in that node. As the fact 215 from the working memory 260 propagate through the logical network, the pattern matcher 255 evaluates the fact 215 against the network node by comparing the fact 215 to the network node and creates an instance of the network node to be executed based on the fact 215 matching the network node. In some implementations, when the fact 215 causes all of the patterns for the nodes in a given path to be satisfied, a leaf node is reached, and the corresponding rule is determined to have been matched by the fact.

In some implementations, the pattern matcher 255 can compare a character element (e.g., type) of a fact to a constant string (e.g., “standard”) in a constraint (type “standard”). In some implementations, the pattern matcher 255 can identify which of the constraints are mutually exclusive that cannot be true simultaneously when evaluated on a same character element.

The matched rules, i.e., the rules that have their respective constraints matched against asserted facts, can define actions to be performed, i.e., actions specified by the matched rules, and are placed into the agenda 259. The agenda 259 is a data store, which provides a list of rules to be executed and the objects on which to execute the rules. The rules engine 250 may iterate through the agenda 259 to trigger the actions sequentially. Alternatively, the rules engine 250 may execute the actions in the agenda 259 randomly. As such, the rule engine 250 can receive the rules 205 from the rule repository 240 and evaluate the rules 205 against objects 215 from the working memory 260, and the matched rules and actions from the evaluation are saved in the agenda 259.

The rule engine 250 can derive or identify one or more objects from the evaluation of the rules. Specifically, the rule engine 250 can derive objects from executing the actions specified by the matched rules. For example, when a SubscriptionSpec object is matched with a condition specified by an API rule showed in FIG. 3B, the rule engine 250 can derive an Allocation object as a result of the execution of the action specified by the API rule showed in FIG. 3B. The Allocation object can be a domain-knowledge API object. In another example, when the Allocation object is matched with a condition specified by an API rule showed in FIG. 3C, the rule engine 250 can derive a StatefulSet object as a result of the execution of the action specified by the API rule showed in FIG. 3C. The StatefulSet object can be a standard API object. In some implementations, the rule engine 250 derives or identifies an object including a matched fact and/or corresponding rule. The API object determination component 280 can receive, from the rule engine 250, one or more derived object and determine whether each object is an API object of the cluster 210. An API object of the cluster 210 refers to a persistent entity in the API database of the cluster 210 that represents the state of the cluster 210, for example, including what containerized applications are running (and on which nodes), the resources available to those applications, and the policies around how those applications behave, such as restart policies, upgrades, and fault-tolerance. In some implementations, the API object of the cluster 210 includes two nested object fields that govern the object's configuration: the object spec providing a description of its desired state and the object status providing a description of the current state of the object, supplied and updated by the cluster 210.

In some implementations, the object may include an indication (e.g., a flag bit) that represents the object is a standard or domain-knowledge API object applicable to the cluster 210, and the API object determination component 280 may use this indication to determine whether the object is an API object of the cluster 210. In some implementations, the API object determination component 280 may compare the object with the existing objects of the cluster 210 and determine that the object is an API object of the cluster 210 when there is a match.

Responsive to determining that any object is an API object of the cluster 210, the API object determination component 280 can send the object to the API object addition component 290. In response, the API object addition component 290 can add the object to the cluster 210. In some implementations, the API object addition component 290 adds the object to the API database of the cluster 210. In some implementations, the API object addition component 290 applies the object to the cluster 210 (by invoking a designed service, from the store 238, dedicated to applying new or modified objects to the cluster 210).

After applying the object to the cluster 210, the working memory may be updated, and new or modified fact can be supplied to the rule engine 250. The rule engine may evaluate the rule against the new or modified fact and repeat the process described above, including the process performed with the API object determination component 280 and the API object addition component 290. In some implementations, the process may recursive until no more unprocessed object exists, which will be described in detail with respect to FIG. 5.

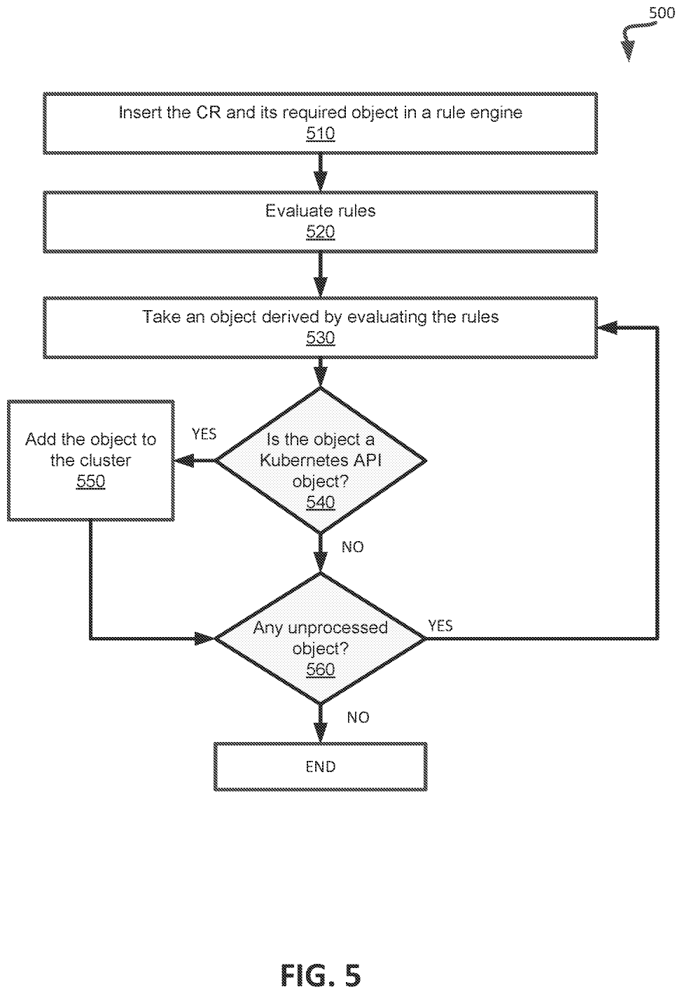

FIG. 4 depicts a flow diagram of an illustrative example of a method 400 for implementing a rule engine with an operator framework to define business domain logic while orchestrating custom resources in the operator framework, in accordance with one or more aspects of the present disclosure. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processes implementing method 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Method 400 may be performed by processing devices of a server device or a client device. The processing device includes a rule engine that is capable to create rules and evaluate rules. At operation 410, the processing device inserts, into an API rule, a data item associated with a service defined by an application programming interface (API), wherein the rule includes at least one constraint including the data item and at least one action to perform if the at least one constraint of the rule is satisfied. The data item associated with the service defined by the API may include Custom Resource (CR) data, for example, SubscriptionSpec having type “standard,” as shown in the example of FIG. 3B. The data item associated with the service defined by the API may include data resulted from processing Custom Resource (CR) data through a rule evaluation, for example, Allocation, as shown in the example of FIG. 3C. In some implementations, the processing device may insert the data item into the at least one constraint of the API rule. In some implementations, the processing device may create the API rule, including inserting the data item. In some implementations, the processing device may modify the API rule by inserting the data item.

As described previously, the rule engine receives a set of rules to be evaluated by the rule engine for executing custom business logic, and each rule includes a predicate associated with a constraint on the left-hand side and a production on the right-hand side. Inserting the data item associated with the service defined by the API into the API rule and evaluating the API against the facts from the working memory can allow the client to code custom logic in a more scalable way, instead of re-coding each time any change applies to the custom logic. The set of rules may be defined based on an executable model language, such as, for example, an executable model that is used to generate Java source code representation of the set of rules associated with the custom business logic, providing faster startup time and better memory allocation.

At operation 420, the processing logic derives an object through evaluating, by the rule engine, the API rule. As described previously, the rule engine evaluates the API rule against an asserted fact received from a working memory. The rule engine may evaluate the API rule by comparing the asserted fact to the at least one constraint of the API rule and generate an object from executing the action corresponding to the matched rule.

At operation 430, the processing logic determines whether the object derived from evaluating the rule is an application programming interface (API) object of a containerized computing cluster, wherein the containerized computing cluster includes one or more virtual machines running on one or more host computer systems. The API object of the containerized computing cluster may include one or more of: a default API object or a domain knowledge API object.

At operation 440, the processing logic, responsive to determining that the object derived from evaluating the rule is an API object of the containerized computing cluster, adds the object to a definition of the containerized computing cluster. In some implementations, the processing logic may add the object by storing the object in a data structure associated with the containerized computing cluster. In some implementations, the processing logic may use a result from adding the object to obtain a new or modified asserted fact, and the processing logic may recursively process by evaluating the rule against the new or modified asserted fact to obtain a new object, and determine whether the object is the API object and whether to add the object to the definition of the cluster accordingly. The process can be continued until there is no unprocessed object, which will be illustrated with respect to FIG. 5.

FIG. 5 depicts a flow diagram of an illustrative example of a method 500 for implementing a rule engine with an operator framework to define business domain logic while orchestrating custom resources in the operator framework, in accordance with one or more aspects of the present disclosure. Method 500 and each of its individual functions, routines, subroutines, or operations may be performed by one or more processors of the computer device executing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processes implementing method 500 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Method 500 may be performed by processing devices of a server device or a client device. The processing device includes a rule engine that is capable to create rules and evaluate rules. At operation 510, the processing logic inserts the CR item and its required object in a rule engine, which means that the rules to be evaluated and the facts asserted to the working memory would be ready for use in the rule engine. As described previously, the processing logic may create an API rule using CR item. The processing logic may insert the CR item to an API rule, which may be the same as or similar to operation 410. The processing logic may assert the facts (e.g., a fact associated with the CR) to the working memory of the rule engine.

At operation 520, the processing logic evaluates the rules, and at operation 530, the processing logic takes an object derived from evaluating the rules. Operations 520 and 530 may be the same as or similar to operation 420. In some implementations, the rules may include all rules available to the processing logic. In some implementations, the rules may include API rules and non-API rules.

At operation 540, the processing logic determines whether the object is an application programming interface (API) object of a containerized computing cluster, wherein the containerized computing cluster includes one or more of virtual machines running on one or more host computer systems, which may be the same as or similar to operation 430.

If the processing logic determines that the object is an application programming interface (API) object of the containerized computing cluster, the processing logic, at operation 550, adds the object to the containerized computing cluster (e.g., adds the object to the API database by means of dedicated services, functions, or routines in the containerized computing cluster), which may be the same as or similar to operation 440. If the processing logic determines that the object is not an application programming interface (API) object of the containerized computing cluster, the processing logic, at operation 560, determines whether there exists an unprocessed object among the objects derived from evaluating the rules. If the processing logic determines that there exists an unprocessed object among the objects derived from evaluating the rules, the processing logic processes back to operation 530 to take the unprocessed object and continues with operation 540 and so on. In some implementations, the processing logic may process back to operation 520 to evaluate the rules if any changes happen to the rules or asserted facts after the last time operation 520 performs.

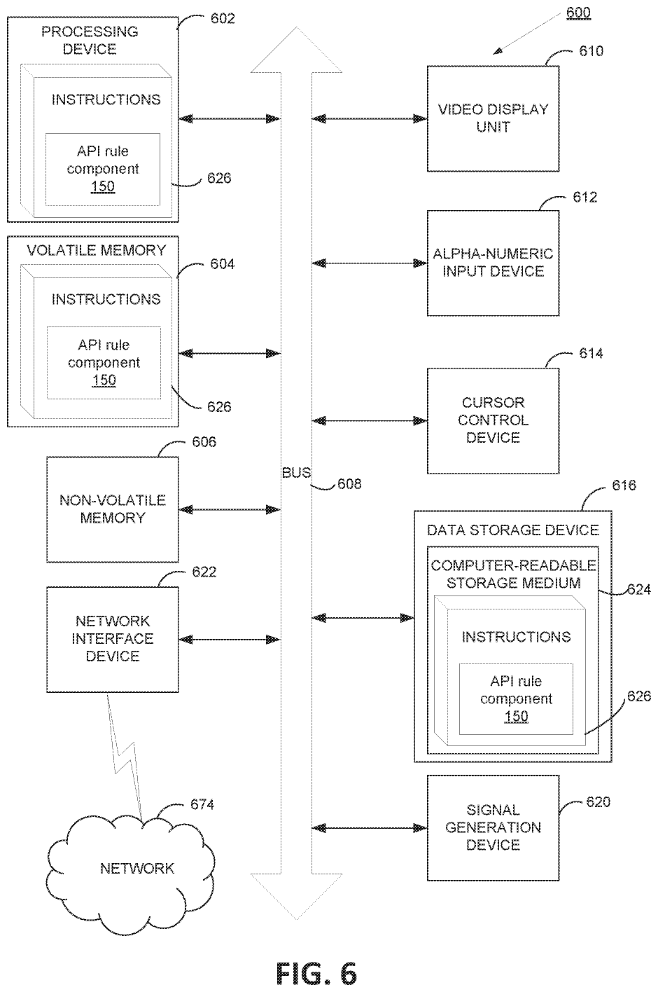

FIG. 6 depicts an example computer system 600, which can perform any one or more of the methods described herein. In one example, computer system 600 may correspond to computer system 100 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a set-top box (STB), a server, a network router, switch or bridge, or any device capable of executing a set of instructions (sequential or otherwise) that specify actions to be taken by that device. Further, while a single computer system is illustrated, the term “computer” shall also be taken to include any collection of computers that individually or jointly execute a set (or multiple sets) of instructions to perform any one or more of the methods discussed herein.

The exemplary computer system 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application-specific integrated circuit (ASIC), a field-programmable gate array (FPGA), a digital signal processor (DSP), network processor, or the like. The processing device 602 is configured to execute processing logic (e.g., instructions 626) that includes the API rule component 150 for performing the operations and steps discussed herein (e.g., corresponding to the method of FIGS. 4-5, etc.).

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker). In one illustrative example, the video display unit 610, the alphanumeric input device 612, and the cursor control device 614 may be combined into a single component or device (e.g., an LCD touch screen).

The data storage device 616 may include a non-transitory computer-readable medium 624 on which may store instructions 626 that include API rule component 150 (e.g., corresponding to the methods of FIGS. 4-5) embodying any one or more of the methodologies or functions described herein. API rule component 150 may also reside, completely or at least partially, within the main memory 604 and/or within the processing device 602 during execution thereof by the computer system 600, the main memory 604, and the processing device 602 also constituting computer-readable media. API rule component 150 may further be transmitted or received via the network interface device 622.

While the computer-readable storage medium 624 is shown in the illustrative examples to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Other computer system designs and configurations may also be suitable to implement the systems and methods described herein.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative and not restrictive. Many other implementations will be apparent to those of skill in the art upon reading and understanding the above description. Therefore, the scope of the disclosure should be determined with reference to the appended claims, along with the full scope of equivalents to which such claims are entitled.

In the above description, numerous details are set forth. However, it will be apparent to one skilled in the art that aspects of the present disclosure may be practiced without these specific details. In some instances, well-known structures and devices are shown in block diagram form rather than in detail in order to avoid obscuring the present disclosure.

Unless specifically stated otherwise, as apparent from the following discussion, it is appreciated that throughout the description, discussions utilizing terms such as “receiving,” “determining,” “providing,” “selecting,” “provisioning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for specific purposes, or it may include a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general-purpose systems may be used with programs in accordance with the teachings herein, or it may prove convenient to construct a more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, the use of the term “an embodiment” or “one embodiment” or “an implementation” or “one implementation” throughout is not intended to mean the same embodiment or implementation unless described as such. Furthermore, the terms “first,” “second,” “third,” “fourth,” etc., as used herein, are meant as labels to distinguish among different elements and may not have an ordinal meaning according to their numerical designation.

What is claimed is:

1. A method comprising:
identifying an object by processing, by a processing device implementing a rule engine that utilizes a rule, a data item associated with a service defined by an application programming interface (API), wherein the data item associated with the service defined by the API comprises Custom Resource (CR) data;
determining whether the object is an API object of a containerized computing cluster, wherein the containerized computing cluster comprises a plurality of virtualized computing environments running on one or more host computer systems; and
responsive to determining that the object is an API object of the containerized computing cluster, adding the object to a definition of the containerized computing cluster.

2. The method of claim 1, wherein the rule specifies at least one constraint and at least one action to perform if the at least one constraint is satisfied.

3. The method of claim 2, further comprising: creating an API rule by inserting the data item into the at least one constraint specified by the rule.

4. The method of claim 2, wherein identifying the object comprises:
receiving a fact from a working memory;
evaluating the rule against the fact by comparing the fact to the at least one constraint specified by the rule; and
responsive to matching the fact to the at least one constraint of the rule, generating the object by executing the at least one action.

5. The method of claim 2, further comprising:
generating or updating a second fact as a result of adding the object;
evaluating the rule against the second fact by comparing the second fact to the at least one constraint specified by the rule; and
responsive to matching the second fact to the at least one constraint specified by the rule, generating a second object;
determining whether the second object is an API object of the containerized computing cluster; and
responsive to determining that the second object is an API object of the containerized computing cluster, adding the second object to the definition of the containerized computing cluster.

6. The method of claim 1, further comprising:
determining whether there is an unprocessed object;
responsive determining that there is an unprocessed object, determining whether the unprocessed object is an API object of the containerized computing cluster; and
responsive to determining that the unprocessed object is an API object of the containerized computing cluster, adding the unprocessed object to the definition of the containerized computing cluster.

7. The method of claim 1, further comprising:
creating or modifying the Custom Resource (CR) data.

8. The method of claim 1, wherein the API object of the containerized computing cluster comprises at least one of: a default API object or a domain knowledge API object.

9. A system comprising:
a memory;
a processing device coupled to the memory, the processing device to perform operations comprising:
processing a data item associated with a service defined by an application programming interface (API), wherein the data item associated with the service defined by the API comprises Custom Resource (CR) data;
deriving, through evaluating the rule including the data item, an object;
determining whether the object is an API object of a containerized computing cluster, wherein the containerized computing cluster comprises a plurality of virtualized computing environments running on one or more host computer systems; and
responsive to determining that the object is an API object of the containerized computing cluster, adding the object to a definition of the containerized computing cluster.

10. The system of claim 9, the rule comprises at least one constraint and at least one action to perform if the at least one constraint is satisfied.

11. The system of claim 9, wherein the processing device to further perform operations comprising: creating the rule including the data item.

12. The system of claim 10, wherein deriving the object comprises:
receiving an asserted fact from a working memory of the processing device;
evaluating the rule against the asserted fact by comparing the asserted fact to the at least one constraint of the rule; and
responsive to matching the asserted fact to the at least one constraint of the rule, generating the object by executing the at least one action.

13. The system of claim 10, wherein the processing device to further perform operations comprising:
generating or updating a second asserted fact as a result of adding the object;
evaluating the rule against the second asserted fact by comparing the second asserted fact to the at least one constraint of the rule; and
responsive to matching the second asserted fact to the at least one constraint of the rule, generating a second object;
determining whether the second object is an API object of the containerized computing cluster; and
responsive to determining that the second object is an API object of the containerized computing cluster, adding the second object to the definition of the containerized computing cluster.

14. The system of claim 9, wherein the processing device to further perform operations comprising:
determining whether there is an unprocessed object;
responsive determining that there is an unprocessed object, determining whether the unprocessed object is an API object of the containerized computing cluster; and
responsive to determining that the unprocessed object is an API object of the containerized computing cluster, adding the unprocessed object to the definition of the containerized computing cluster.

15. The system of claim 9, wherein the processing device to further perform operations comprising:
creating or modifying the Custom Resource (CR) data.

16. The system of claim 9, wherein the API object of the containerized computing cluster comprises at least one of: a default API object or a domain knowledge API object.

17. A non-transitory computer-readable storage medium comprising instructions that, when executed by a processing device, cause the processing device to perform operations comprising:
processing a data item associated with a service defined by an application programming interface (API), wherein the data item associated with the service defined by the API comprises Custom Resource (CR) data;
identifying, through evaluating a rule including the data item, an object;
determining whether the object is an API object of a containerized computing cluster, wherein the containerized computing cluster comprises a plurality of virtualized computing environments running on one or more host computer systems; and
responsive to determining that the object is an API object of the containerized computing cluster, adding the object to a definition of the containerized computing cluster.

18. The non-transitory computer-readable storage medium of claim 17, wherein the rule specifies at least one constraint and at least one action to perform if the at least one constraint is satisfied.

19. The non-transitory computer-readable storage medium of claim 17, wherein the API object of the containerized computing cluster comprises at least one of: a default API object or a domain knowledge API object.

20. The non-transitory computer-readable storage medium of claim 18, wherein identifying the object comprises:
receiving a fact from a working memory;
evaluating the rule against the fact by comparing the fact to the at least one constraint specified by the rule; and
responsive to matching the fact to the at least one constraint specified by the rule, generating the object by executing the at least one action.
